(19) United States
(12) Patent Application Publication
(10) Pub. No.: US 2026/0270685 A1
(43) Pub. Date: Sep. 10, 2026

(54) METHODS AND WIRELESS NETWORK FOR HANDLING TEMPORARY UE CAPABILITY CHANGES FOR MUSIM DEVICE

(71) Applicant: Samsung Electronics Co., Ltd., Suwon-si, Gyeonggi-do (KR)

(72) Inventors: Aby Kanneath ABRAHAM, Bangalore (IN); Vinay Kumar SHRIVASTAVA, Bangalore (IN)

(21) Appl. No.: 19/164,464

(22) PCT Filed: Mar. 28, 2024
(86) PCT No.: PCT/KR2024/003999

§ 371 Date: Sep. 11, 2025

(30) Foreign Application Priority Data
Apr. 6, 2023 (IN) 202341026104
Mar. 22, 2024 (IN) 202341026104

(51) Int. Cl. H04W 8/24; H04W 8/18; H04W 76/27

(52) U.S. Cl. CPC H04W 8/24; H04W 8/183; H04W 76/27

(57) ABSTRACT

The disclosure relates to a 5G or 6G communication system for supporting a higher data transmission rate. Embodiments herein disclose methods for handling a temporary UE capability change for a Multi SIM device (100) in a wireless network (1000) by a first UE (110) of the Multi-SIM device (100). The method includes completing a RRC procedure successfully upon receiving a configuration in a RRC message from a network entity (210 or 220). The configuration is not supported by a restricted temporary capability. Further, the method includes sending a complete message corresponding to the RRC procedure.

### TECHNICAL FIELD Embodiments disclosed herein relate to a wireless network, and more particularly to managing Multi-SIM (MUSIM) devices in the wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources

### DISCLOSURE OF INVENTION

### Technical Problem

The principal object of the embodiments herein is to disclose methods and a wireless network for handling temporary UE capability changes for a MUSIM operation.

Another object of the embodiments herein is to disclose a UE behaviour when a network entity sends a RRCResume with a set of configurations not supported according to temporary capability restrictions for the MUSIM operation.

Another object of the embodiments herein is to disclose a UE behaviour when the network entity sends a RRCReconfiguration with a set of configurations not supported according to temporary capability restrictions for the MUSIM operation.

Another object of the embodiments herein is to handle RRCReestablishment when there are temporary capability restrictions reported by the UE.

### Solution to Problem

Accordingly, the embodiments herein provide methods for handling a temporary UE capability change for a Multi Subscriber Identity Module (SIM) device in a wireless network. The method includes completing, by a first UE of a Multi-SIM device, a RRC procedure successfully upon receiving a configuration in a RRC message from a network entity. The configuration is not supported by a restricted temporary capability. Further, the method includes sending, by the first UE of the Multi-SIM device, a complete message corresponding to the RRC procedure.

In an embodiment, the complete message is a RRCResumeComplete, and the RRC message is a RRCResume message.

In an embodiment, the configuration includes at least one of: a MIMO configuration, a band related information, a band combination related information, a carrier aggregation related configuration and a dual connectivity related configuration.

In an embodiment, the first UE accepts the RRC message when the first UE is configured for reporting the restricted temporary capability changes by the network entity.

In an embodiment, the first UE fails a RRCResume procedure when the first UE is not configured for reporting the restricted temporary capability changes by the network entity.

In an embodiment, the first UE fails a RRCReconfguration procedure and avoids to send RRCReconfigurationComplete when the first UE receives capabilities not supported by the temporary capabilities.

In an embodiment, the restricted temporary capability changes informed by the first UE to the network entity comprises information to determine at least one of: whether the first UE performs inter-frequency SSB based measurements without measurement gaps when the SSB is completely contained in an active bandwidth part (BWP), whether the first UE performs intra-frequency SSB based measurements without measurement gaps, and whether the first UE performs intra-frequency CSI-RS measurements without measurement gaps, wherein the restricted temporary capability changes are due to MUSIM operations and the network entity receives the information from the first UE and takes an action, wherein the action is used to allocate measurement gaps when the measurement is configured.

In an embodiment, the restricted temporary capability changes informed by the first UE to the entity comprises information to determine whether the first UE performs inter-frequency L1 measurements required for Lower Layer Triggered Mobility (LTM) without measurement gaps, and whether the first UE performs intra-frequency L1 measurements required for Lower Layer Triggered Mobility (LTM) without measurement gaps, wherein the network entity receives the information from the first UE and takes an action, wherein the restricted temporary capability changes informed by the first UE is due to MUSIM operations, wherein the network entity receives the information from the first UE and takes an action wherein the action is used to allocate measurement gaps when the measurement is configured.

In an embodiment, the method includes sending, by the network entity, a latest UE capability and a request for temporary UE capability changes received from a first UE to a second gNB during the UE context retrieval procedure for one of: a RRC Reestablishment and a RRC Resume. The network entity is one of: a first gNB and an operations, administration, maintenance (OAM) entity.

Accordingly, the embodiments herein provide methods for handling a temporary UE capability change for a MUSIM in a wireless network. The method includes receiving, by a first network entity, a message for temporary capability change from a first UE of a multi-sim device. In an embodiment, the method includes accepting all the temporary capability changes requested by the first UE and sending a RRC Reconfiguration message to inform acceptance all the temporary capability changes requested by the first UE to the multi-sim device. In another embodiment, the method includes rejecting all the temporary capability changes requested by the first UE and sending a RRC Reconfiguration message to inform rejection all the temporary capability changes requested by the first UE to the multi-sim device.

Accordingly, the embodiments herein provide a UE including a temporary UE capability handling controller coupled with a processor and a memory. The temporary UE capability handling controller is configured to complete a RRC procedure successfully upon receiving a configuration in a RRC message from a network entity, where the configuration is not supported by a restricted temporary capability. Further, the temporary UE capability handling controller is configured to send a complete message corresponding to the RRC procedure.

Accordingly, the embodiments herein provide a first network entity including a temporary UE capability handling controller coupled with a processor and a memory. The temporary UE capability handling controller is configured to receive a message for temporary capability change from a first UE of a multi-SIM device. In an embodiment, the temporary UE capability handling controller is configured to accept all the temporary capability changes requested by the first UE and sending a RRC Reconfiguration message to inform acceptance all the temporary capability changes requested by the first UE to the multi-sim device. In another embodiment, the temporary UE capability handling controller is configured to reject all the temporary capability changes requested by the first UE and sending a RRC Reconfiguration message to inform rejection all the temporary capability changes requested by the first UE to the multi-sim device.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

Aspects of the present disclosure provide an efficient communication methods in a wireless communication system.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates an overview of a wireless network for handling a temporary UE capability change for a Multi-SIM device, according to the embodiments as disclosed herein;

FIG. 2 illustrates various hardware components of the Multi-SIM device, according to the embodiments as disclosed herein;

FIG. 3 illustrates various hardware components of a first network entity, according to the embodiments as disclosed herein;

FIG. 4A illustrates a flow chart illustrating a method, implemented by the Multi-SIM device, for handling the temporary UE capability change for the Multi-SIM device, according to the embodiments as disclosed herein;

FIG. 4B illustrates a flow chart illustrating a method, implemented by the Multi-SIM device, for handling the temporary UE capability change for the Multi-SIM device based on a RRCReconfiguration, according to the embodiments as disclosed herein;

FIG. 4C illustrates a flow chart illustrating a method, implemented by the Multi-SIM device, for handling the temporary UE capability change for the Multi-SIM device based on a RRCResume, according to the embodiments as disclosed herein;

FIG. 5 illustrates a flow chart illustrating a method, implemented by the first network entity, for handling the temporary UE capability change for the Multi-SIM device, according to the embodiments as disclosed herein;

FIG. 6 illustrates a flow chart illustrating a process of UE capability handling during RRC Re-establishment and RRC Resume, according to embodiments as disclosed herein;

FIG. 7 illustrates a flow chart illustrating a process of RRC Configuration handling with temporary capabilities, according to embodiments as disclosed herein; and

FIG. 8 illustrates a block diagram illustrating a structure of a UE according to embodiment as disclosed herein; and

FIG. 9 illustrates a block diagram illustrating a structure of a base station according to embodiment as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

Multi-SIM (MUSIM) devices, that host more than one Subscriber Identity Module (SIM), have the facility to connect to two or more different networks (NWs) in order to avail different data plans, have user profiles like home and office, increased connectivity/reliability with multiple connections etc. In order to save on the cost, radio frequency (RF) circuitry used by the UE is common for multiple SIMs. That implies, multiple SIMs need to arbitrate and share a common RF resource among themselves to perform their activities and/or avail services. Effectively, only one SIM and its associated protocol stack can be served at a time. Meanwhile, all other SIMs and their associated protocol stacks will be waiting for the RF resource to be available for them.

One or more of the multiple SIMs can be engaged in paging reception, system information block (SIB) acquisition, measurement, data or voice call, Multimedia broadcast multicast service (MBMS), emergency call, access stratum (AS) signaling, Non-access stratum (NAS) signaling and so on.

MUSIM UEs used to operate without network control by creating arbitrary gaps till 3GPP decided to introduce support for MUSIM device operations in Release 17. From Release 17, a connected USIM (USIM herein means a radio protocol stack associated with the UE) in the MUSIM device can notify a connected mode network on the network switching for the multi-SIM operations. There are two types of network switching supported. In the first type of switching, the connected USIM leaves the connected network and completely switches to the other USIM (i.e., the other USIM becomes connected). In a second type of switching, the connected USIM requests for the gap from its network for the MUSIM operations like listening for paging or performing measurements in the idle USIM.

In release 17, the MUSIM UE uses radio resource control (RRC) UE Assistance Information (UAI) procedure to request for gaps or to notify about leaving. The network (e.g., gNB or the like) configures the UE whether the network can provide the assistance information for the MUSIM gaps or MUSIM Leave using otherConfig in RRC messages. Musim-GapAssistanceConfig in the otherConfig is used for informing the UE whether it can provide MUSIM assistance information for providing gap information. In release 17, only per-UE gaps are supported for the MUSIM operations. The 3GPP Release 18 aims to support the MUSIM UEs which can support the operation of two USIMs in RRC_CONNECTED at the same time, also known as DSDA (Dual SIM Dual Active).

UE Capabilities: In a technology like fifth generation new radio (5G NR), different UEs may have different hardware and software capabilities. Varying capabilities across devices could be hardware capabilities including radio frequency capabilities like bands or band combinations supported, processing capabilities (e.g., baseband computational capabilities), software capabilities like the support of various features, layer 1 capabilities, layer 2 capabilities, layer 3 capabilities and so on. In general, the UE reports its UE radio access capabilities which are static at least when the network requests the capabilities using UE Capability enquiry procedure. To limit signalling overhead, the gNB (e.g., 5G NR base station) can request the UE to provide NR capabilities for a restricted set of bands. When responding, the UE can skip a subset of the requested band combinations when the corresponding UE capabilities are the same. If supported by the UE and the network, the UE may provide an identifier (ID) in NAS signalling that represents its radio capabilities for one or more RATs in order to reduce signalling overhead. The ID may be assigned either by a manufacturer or by a serving Public Land Mobile Network (PLMN). The manufacturer-assigned ID corresponds to a pre-provisioned set of capabilities. In the case of the PLMN-assigned ID, the assignment takes place in the NAS signaling. Detailed list of UE capabilities that are exchanged based on aforementioned methods is specified in the 3GPP technical specifications like TS 38.306.

The 5G gNB provides the UE with various configurations/features through RRC messages like RRC reconfiguration or RRC resume based on the reported UE capability.

RRC States: In NR, the RRC can be in one of the three states—RRC_IDLE, RRC_INACTIVE or RRC_CONNECTED. An RRC_CONNECTED UE is in CM-CONNECTED (i.e., connected to the 5G Core network) and can do unicast and multicast/broadcast traffic with the network. The network stores UE AS context, knows the UE at cell level and controls the UE mobility. The UE may perform measurements and report to the network and provides channel quality and feedback information etc. The network may send RRCReconfiguration message to change the configuration of the UE.

The RRC_INACTIVE is a state where the UE remains in CM-CONNECTED and can move within an area configured by the NG-RAN (i.e., 5G RAN consisting of gNB(s)) without notifying NG-RAN. In the RRC_INACTIVE, the last serving gNB node keeps the UE context and the first UE associated NG connection (i.e., the connection to the core network). Since the RRC configurations and the connection to core network is kept in the RRC_INACTIVE, the UE can transition immediately to RRC connected state and perform data transfer with the core network/applications. The UE initiates transition to the RRC_CONNECTED from the RRC_INACTIVE by sending an RRC resume request. The UE may further receive RRCResume message from the network to resume the RRC connection and move to the RRC_CONNECTED state.

In RRC_IDLE, the UE or the gNB does not store any Access Stratum (AS) context. The UE is in the CM_IDLE (there is no connection to the core network). The UE sets up a new connection by sending RRC Setup Request message and the gNB sends RRC setup message to transition to the RRC connected. The UE and the NW (both radio access network (RAN) and core network) exchange messages to move the UE to CM_CONNECTED. The UE in RRC_CONNECTED may send power head room to the network according to the TS 38.321 and other relevant 3 gpp specs.

Carrier Aggregation: In Carrier Aggregation (CA), two or more Component Carriers (CCs) are aggregated. The UE may simultaneously receive or transmit on one or multiple CCs depending on its capabilities. The CA is supported for both contiguous and non-contiguous CCs. When the CA is deployed, frame timing and System Frame Number (SFN) are aligned across cells that can be aggregated (synchronous CA), or an offset in multiples of slots between the PCell/PSCell and an SCell is configured to the UE (Asynchronous CA). The UE in the inactive mode may store the CA configuration. In the CA, PCell or Primary Cell is the cell that is used for initial access while other cells are called Scells or secondary cells.

Multi-Radio Dual Connectivity: Dual connectivity or more technically multi-radio dual connectivity is specified by the 3GPP in specifications such as TS 37.340. A summary of the details on the dual connectivity is given below.

The NG-RAN supports Multi-Radio Dual Connectivity (MR-DC) operation whereby the UE in the RRC_CONNECTED is configured to utilize radio resources provided by two distinct schedulers, located in two different NG-RAN nodes connected via a non-ideal backhaul, one providing NR (New Radio) access and the other one providing either E-UTRA (Evolved UMTS Terrestrial Radio Access) or NR access. One node act as a master node (MN) and the other as a secondary node (SN). The MN and SN are connected via a network interface and at least the MN is connected to the core network. The NG-RAN supports NG-RAN E-UTRA-NR Dual Connectivity (NGEN-DC), in which the UE is connected to one ng-eNB (a E-UTRA base station that can connect to a 5G core) that acts as the MN and one gNB (e.g., 5G base station) that acts as the SN. The NG-RAN also supports NR-E-UTRA Dual Connectivity (NE-DC), in which the UE is connected to one gNB that acts as the MN and one ng-eNB that acts as the SN. The primary cell of a master or secondary cell group is referred to herein as SpCell. The SpCell of a master cell group is referred to herein as PCell, while SpCell of a secondary cell group is referred to herein as PSCell. In the MR-DC, a group of serving cells can be associated with the Master Node, comprising of the SpCell (PCell) and optionally one or more SCells is called MCG or Master Cell Group. A group of serving cells associated with the Secondary Node, comprising of the SpCell (PSCell) and optionally, one or more SCells (known as Secondary Cell Group (SCG)) in MR-DC, the Frame timing and SFN between the cells in MCG and SCG may not be aligned.

Framework for supporting capability change: Consider the case of the MUSIM UE with two USIMs (i.e. two UEs in same MUSIM device), the first UE (i.e., first USIM) is in the RRC-CONNECTED state with a first network. A second UE (i.e., second USIM) is moving to the RRC_CONNECTED or is transitioning to the RRC_CONNECTED. The first UE provides the information to the first network to release some resources or update some parameters for the operation of the second UE. This information is pertaining to the change of some of the capabilities in the first UE, release of SCG or SCells in the first UE, deactivation of SCG or SCells in the first UE, information that SCG or SCells can be setup or activated in the first UE etc., measurement gaps requirements (needforgaps/needforgapsorncsg) related information in the first UE to facilitate operations of the second UE.

If the capability of the first UE needs to be changed due to the second UE, the first UE indicates the new capabilities to the first network node (or first network entity) (NW-A) in the RRC setup request/RRC resume request. Alternately, the first UE may also indicate that the capability has changed in RRC setup request/RRC resume request. The first network node may request the first UE to send the changed capabilities further and the first UE may report the changed capability in the RRC message (like RRC setup complete or RRC resume complete). The first network node can configure the UE further with the changed capabilities.

When the first UE is in the RRC_CONNECTED mode and the UE capability changes due to activities in the second UE, the first UE informs the first network node about the capability change through the RRC message. This message could be the UE Assistance Information or a new RRC message (for e.g., UE Capability update) or even any existing RRC message. The first UE may directly send the updated UE capabilities to the first network node in the aforesaid RRC message. Alternatively, the first UE may just inform the first network node that the UE capability has changed, and the first network node retrieves the capability through the UE capability retrieval procedure. The first network node sends the RRC message like UE Capability enquiry to first UE and the first UE sends updated capabilities in UE Capability Information. The first network node may store the received capability. To reduce the signaling overhead, the first UE may associate an id with each set of the capabilities and share the id along with the capability to the first network node. Thereafter, the first UE can just share the capability id to indicate that the capability has changed, and the first network node can retrieve the UE capability with the stored capabilities.

If the capability of the first UE has changed (due to the second UE changing the RRC state), when the first UE was in the RRC_IDLE or the RRC_INACTIVE mode, a similar approach as in RRC_CONNECTED can be used. The first UE indicates the new capabilities to the first network node in the RRC messages (like RRC setup request/RRC resume request) or may share the UE capability ID. Alternately, the first UE may also just indicate that the capability has changed in RRC setup request/RRC resume request. The first network node may request the first UE to send the changed capabilities further and the first UE may report changed capability in RRC message like RRC setup complete or RRC resume complete.

The first UE may report that the capability has changed or may report the changed capabilities based on specific actions in the second UE. When the second UE is handed over from a licensed frequency to an unlicensed frequency or from one FR (frequency range) to another FR, the first UE may report the capability change to the first network node. Alternatively, the first network node may configure the first UE about reporting the capabilities, e.g., through “otherConfig” in the RRC Reconfiguration message. Accordingly, the UE can report the updated or changed capabilities with UE assistance information message. The information contents of the UAI can pertain to MUSIM assistance information or MUSIM UE capability information. A prohibit timer may be configured to control how frequently the UE can report the capability update. The capability update, for e.g., the scheduling pattern and/or Time-Division Duplex (TDD) uplink/downlink (UL/DL) config information pertaining to the second UE as capability limitation (e.g., number of Tx/Rx) to the first UE are not static or fully prohibitive. So, the UE can initiate UAI while prohibit timer is not running to handle such updates.

The first network node may configure the first UE with a filter and the first UE will report the change of capabilities based on the filter. For example, if a capability included in the filter changes, the first UE may report the capability change. If none of the capabilities in the filter changes (due to actions of the second UE), the first UE may not initiate the messages to indicate UE capability change. An example set of IEs that could be included in the filter can be requestedFreqBandsNR-MRDC, requestedCapabilityNR, eutra-nr-only flag, and requestedCapabilityCommon, UE-CapabilityRequestFilterNR. Further, a source and target gNB can exchange the changed capabilities and requested filter during a handover or transition from RRC_INACTIVE or any other Xn (Xn is the interface between two gNBs) UE information retrieval procedure.

The first network node also may indicate if it supports one or more slices or services like vehicle to everything (V2X)/Multicast and Broadcast Service (MBS) when simultaneous RRC connection are supported. The first UE may request/inform the first network node for releasing the said slice or service (or the RRC connection with the first network node) if the MUSIM device decides to allow establishing RRC connection for the second UE. If the device decides to proceed with service/slice in first UE, the second UE RRC will inform the second UE NAS that an RRC connection cannot be established. If the second UE NAS has requested the RRC Connection establishment (due to a paging message), the second UE NAS may send busy indication to its Access and Mobility Management Function (AMF). In some implementations, the second UE RRC may send the busy indication instead of the second UE NAS.

If the bands supported by the changed capability is different from the older capability, the first network node may reconfigure the first UE to release one or more SCells, SCG or perform handover etc. the first network node may configure the first UE to report any available measurements when the capabilities are changed. Since the changed capability can be different from older capability, the first network node may prefer to change the scells or SCG rather than releasing them, or in a case perform handover to a different frequency. Measurements from the UE can aid the network to take such decisions.

Further, whenever the RRC_CONNECTED UE (such as first UE) reports the modified capabilities, it sends any available measurements to the gNB (i.e., first network node). The measurements may be sent in the same RRC message which reports change of capabilities or a different RRC message like measurement report may be sent along with the RRC message which reports change of capabilities.

If any of the NAS capabilities changes (due to the second UE changing RRC state), the first UE may send the NAS message (like registration request) and trigger a reregistration with the changed capabilities. As in the RRC case, if the AMF cannot support certain services with the capability change, device needs to prioritize between services of the first UE and the second UE.

The static or dynamic capability signaling reported by the UE may include the below and many more.
a) Number of Rx links;
b) Number of Tx links;
c) Number of MIMO layers;
d) Support for CA or DC on a second network node (second network entity) (NW-B);
e) Processing capability in terms of supportable component carriers or dual connectivity on the first network node;
f) Request for at least one of configuration, activation, deactivation and release of one or more SCell/SCG on the first network node;
g) Supported band(s) or band combination(s);
h) UL or DL TDD configuration;
i) Scheduling information or configuration;
j) DRX configuration on the second network node;
k) Measurement configuration on the second network node;
l) IDC related configuration or parameters; and
m) Power control or back-off parameters.

The network utilizes the updated capability received from the UE and reconfigures the UE with updated parameters. The network may update configuration of dual connectivity, carrier aggregation, power control, interference coordination, DAPS configuration, number of layers etc. based on the capability information including supported bands, supported band combination, scheduling pattern and/or TDD UL/DL config information etc.

The network may receive the updated capabilities, thus received as temporary UE capability and the methods as temporary UE capability changes. This temporary capability may not be stored in the core network. The UE capabilities are stored in the AMF and reported through UE capability information procedure (as in R17), which can be referred as the permanent UE capabilities or permanent capabilities.

In the current system, the permanent UE capability is reported using the UE Capability Transfer procedure. The gNB requests the UE to report the UE capabilities by sending UECapabilityEnquiry message and the UE reports the capabilities using UE-CapabilityInformation message. The reported capabilities are sent to the core network and stored there so that every time, the UE moves from RRC_IDLE or RRC_INACTIVE to RRC_CONNECTED, there is no need to send the capabilities over the air. UECapabilityEnquiry message may include CapabilityRequestFilter (as defined in TS 38.331 RRC specification), so that the UE reports only the required information for the network. If the UE receives the RRCReconfiguration message including some capabilities which are not supported in the UE as reported through the UE Capability Transfer procedure, the UE fails the procedure. Further, the UE may move to the RRC Reestablishment procedure. The RRC Reestablishment procedure also may be initiated in case of other failures such as Radio Link Failures. The behavior of the UE when the RRCReconfiguration message including some capabilities which are not supported in the UE due to the reported temporary capability changes is not yet known.

If the UE receives RRCResume message including some capabilities which are not supported in the UE as reported through the UECapabilityEnquiry procedure, the UE fails the procedure. Further, the UE may move to RRC_IDLE. The behavior of the UE when the RRCReconfiguration message including some capabilities which are not supported in the UE due to the reported temporary capability changes is not yet known.

3GPP can also consider LowerLayerTriggered Mobility for performing handover. Further, v17.4.0 of 3GPP specifications such as TS 38.331, TS 38.300, TS 38.306, TS 38.321 can be further considered as relevant background.

Consider the case of the MUSIM UE with two USIMs (i.e., two UEs in same MUSIM device), the first UE (also referred to as first USIM) is in RRC-CONNECTED state with the first network. The second UE (also referred to as second USIM) is in RRC_CONNECTED state with the second network entity or is moving to RRC_CONNECTED or any other trigger occurs in the second network entity, which causes the temporary capability to change. In NR, the first network is the gNB to which the first USIM is connected. The first USIM as referred to herein, is technically the radio protocol stack associated with the first USIM.

The first USIM may apply temporary capability changes for the operation of the second USIM in DSDA mode where both the USIMs are in the RRC_CONNECTED or for any other purpose. Currently, the first USIM which has applied temporary capability change, for MUSIM actions, informs its first network while setting up RRC connection. This might be done through a flag or enumerated. Temporary capability change could be temporary capability restriction where the UE capabilities are reduced, or capability increase where the reduced capabilities have been restored or the capabilities have increased.

The above information is presented as background information only to help the reader to understand the present invention. Applicants have made no determination and make no assertion as to whether any of the above might be applicable as prior art with regard to the present application.

The terms “first network node” and “first network entity” are used interchangeably in the patent disclosure. The terms “second network node” and “second network entity” are used interchangeably in the patent disclosure.

The embodiments herein provide methods for handling a temporary UE capability change for a Multi Subscriber Identity Module (SIM) device in a wireless network. The method includes completing, by a first UE of a Multi-SIM device, a RRC procedure successfully upon receiving a configuration in a RRC message from a network entity. The configuration is not supported by a restricted temporary capability. The configuration may be implicit or explicit, for e.g. the Resume may configure the UE to restore the stored configuration for SCells or dual connectivity or may configure the UE to use the stored measurement configurations by not releasing the configurations. Further, the method includes sending, by the first UE of the Multi-SIM device, a complete message corresponding to the RRC procedure.

In an embodiment, if the configured by the network to send early indication (i.e., via SIB1), and if the UE support MUSIM temporary capability restriction, the UE does not apply the failure handling in case it does not apply any part of the configuration for the MUSIM purpose.

In an embodiment, if the UE is configured (i.e., via SIB1) to send the MUSIM temporary capability restriction indication, and if the UE supports MUSIM temporary capability restriction, the UE does not apply the failure handling in case the UE is unable to apply part of the configuration included in RRCResume message due to UE temporary capability restriction for the MUSIM operation.

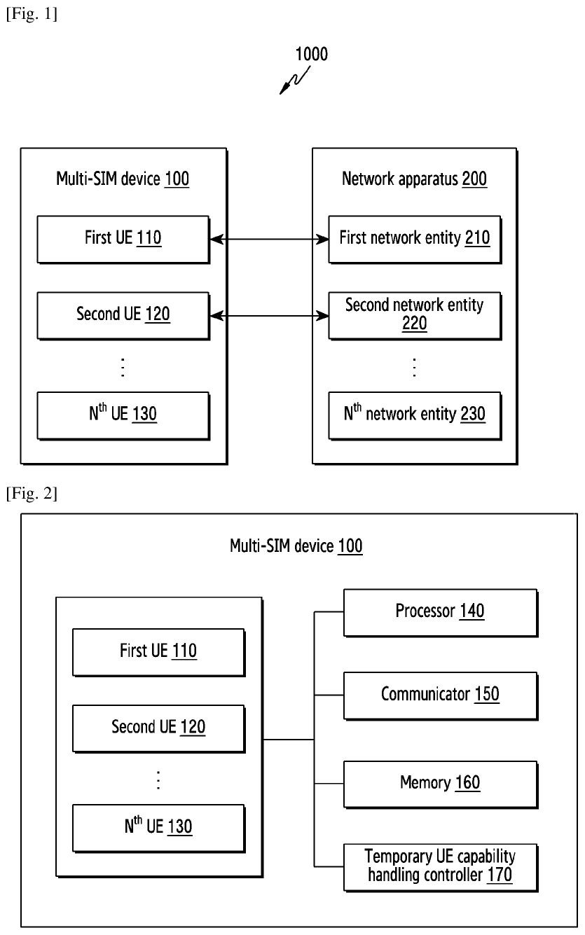

Referring now to the drawings, and more particularly to FIGS. 1 through 9, where similar reference characters denote corresponding features consistently throughout the figures, there are shown at least one embodiment.

FIG. 1 illustrates an overview of a wireless network (1000) for handling a temporary UE capability change for the Multi-SIM device (100), according to the embodiments as disclosed herein. The wireless network (1000) can be, for example, but not limited to a fourth generation (4G) network, a fifth generation (5G) network, a 6G network, an Open Radio Access Network (ORAN) or the like. In an embodiment, the wireless network (1000) includes the Multi-SIM device (100) and a network apparatus (200). The Multi-SIM device (100) includes a plurality of UEs (110-130). Hereafter, the label for the UE is 110. The Multi-SIM device (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (200) includes a first network entity (210), a second network entity (220), and Nth network entity (230).

In an embodiment, the first UE (110) completes the RRC procedure successfully upon receiving a configuration in a RRC message from the network entity (210). The RRC message can be an RRCResume message. In an embodiment, the configuration includes at least one of: a MIMO configuration, a band related information, a band combination related information, a carrier aggregation related configuration and a dual connectivity related configuration. The configuration is not supported by a restricted temporary capability. Further, the first UE (110) sends a complete message corresponding to the RRC procedure. The complete message can be a RRCResumeComplete.

In an embodiment, the first UE (110) accepts the RRC message when the first UE (110) is configured for reporting the restricted temporary capability changes by the network entity. In an embodiment, the first UE (110) fails a RRCResume procedure when the first UE (110) is not configured for reporting the restricted temporary capability changes by the network entity.

In an embodiment, the first UE (110) fails a RRCReconfguration procedure and avoids to send RRCReconfigurationComplete when the first UE (110) receives capabilities not supported by the temporary capabilities.

In an embodiment, the restricted temporary capability changes informed by the first UE (110) to the network entity comprises information to determine at least one of: whether the first UE (110) performs inter-frequency SSB based measurements without measurement gaps when the SSB is completely contained in an active BWP, whether the first UE (110) performs intra-frequency SSB based measurements without measurement gaps, and whether the first UE (110) performs intra-frequency CSI-RS measurements without measurement gaps, where the restricted temporary capability changes are due to MUSIM operations and the network entity receives the information from the first UE (110) and takes an action, where the action is used to allocate measurement gaps when the measurement is configured.

In an embodiment, the restricted temporary capability changes informed by the first UE (110) to the entity comprises information to determine whether the first UE (110) performs inter-frequency L1 measurements required for LTM without measurement gaps, and whether the first UE (110) performs intra-frequency L1 measurements required for the LTM without measurement gaps, where the network entity receives the information from the first UE (110) and takes an action, where the restricted temporary capability changes informed by the first UE (110) is due to MUSIM operations, where the network entity receives the information from the first UE (110) and takes an action where the action is used to allocate measurement gaps when the measurement is configured.

Consider the case of the MUSIM UE with two USIMs (i.e., two UEs in same MUSIM device), the first UE (i.e., first USIM) is in RRC-CONNECTED state with the first network entity (210). The second UE (i.e., second USIM) (120) is in RRC_CONNECTED state with the second network entity (220) or is moving to RRC_CONNECTED or any other trigger occurs in the second network entity (220), which causes the temporary capability to change in the first USIM. In NR, the first network entity (210) is the gNB to which the first USIM is connected. The first USIM is technically the radio protocol stack associated with the first USIM.

In an embodiment, temporary capability changes informed by the first USIM to the first network entity (210) includes whether interFrequencyMeas-NoGap-r16 as in 3GPP specification TS 38.331 v17.4.0 and TS 38.306 V 17.4.0 is supported. The first network entity (210) receives this information from the first USIM and takes appropriate actions.

In an embodiment, temporary capability changes informed by the first USIM to the first network entity (210) includes whether the UE (110) can perform inter-frequency SSB based measurements without measurement gaps if the SSB is completely contained in the active BWP. In an embodiment, the temporary capability changes informed by the first USIM to the first network entity (210) includes whether the first UE (110) can perform intra-frequency SSB based measurements without measurement gaps or whether the UE (110) can perform intra-frequency CSI-RS measurements without measurement gaps. The first network entity (210) receives this information from the first USIM and takes the appropriate actions.

In an embodiment, the temporary capability changes informed by the first USIM to the first network entity (210) includes whether the UE (110) can perform L1 measurements required for the LTM without measurement gaps. The first network entity (210) receives this information from the first USIM and takes the appropriate actions.

In an embodiment, the temporary capability changes informed by the first USIM to the first network entity (210) includes the requirements of measurement gaps for performing L1 measurements required for the LTM. The first network entity (210) receives this information from the first USIM and takes the appropriate actions.

In an embodiment, if the first network entity (210) receives UAI or other message for the temporary capability changes, the first network entity (210) either accepts all of the temporary capability changes requested by the first USIM and informs the first USIM in the RRC Reconfiguration message or informs the first network entity (210) that the request for temporary capability changes are rejected or doesn't respond to the request for temporary capability changes. The first network entity (210) doesn't partially accept the temporary capability changes.

In an embodiment, the first USIM (which has applied temporary capability change) informs its network (i.e., first network entity (210)), while setting up RRC connection when the RRC connection is not setup for performing a new registration or attach., i.e., if the first USIM (which has applied temporary capability restriction) performs new registration or attach to the first network entity (210) and sends RRCSetupRequest for the same, it skips including the flag/enumerated (or sets the flag/enumerated for temporary capability change as false) or the temporary capabilities which informs the first network entity (210) about temporary capability change. In an embodiment, the first USIM informs the first network entity (210) about temporary capability change while setting up the RRC connection only if it has resulted in reduction of capabilities and skips informing the first network entity (210) if the capabilities have increased.

In an embodiment, the first USIM stores the last reported capabilities which are reported using UE Capability Transfer procedure (e.g., UE capability reported in RRC_CONNECTED using UECapabilityInformation) while moving to RRC_IDLE or RRC_INACTIVE. In an embodiment, the first USIM keeps the last reported capabilities which are reported using UE Capability Transfer procedure while it is in RRC_IDLE or RRC_INACTIVE. In an embodiment, the first USIM clears the stored last reported capabilities as in the above embodiments, upon performing detach. In an embodiment, the first USIM clears the last stored last reported capabilities as in the above embodiments during power-off. In an embodiment, the first USIM clears the stored last reported capabilities as in the above embodiments upon attaching (registering) to a different PLMN. In an embodiment, the first USIM clears the stored last reported capabilities as in the above embodiments upon leaving out of MUSIM operation. In an embodiment, the first USIM clears the stored last reported capabilities as in the above embodiments upon going out of DSDA mode of operation.

In an embodiment, the first USIM stores the last received capability filter (e.g., filter CapabilityRequestFilter received in UECapabilityEnquiry message) while moving to RRC_IDLE or RRC_INACTIVE. In an embodiment, the first USIM keeps the last received capability filter as in the above embodiments while it is in RRC_IDLE or RRC_INACTIVE. In an embodiment, the first USIM clears the stored last received capability filter as mentioned above upon performing detach. In an embodiment, the first USIM clears the stored last received capability filter as mentioned above during power-off. In an embodiment, the first USIM clears the stored last received capability filter as mentioned above upon attaching (registering) to a different PLMN. In an embodiment, the first USIM clears the stored last received capability filter as mentioned above upon leaving out of MUSIM operation. In an embodiment, the first USIM clears the stored last received capability filter as mentioned above upon going out of DSDA mode of operation. In an embodiment, the filter could be a filter received in other IEs such as OtherConfig for reporting temporary capability change. In an embodiment, the filter in the above embodiment is a part of filter received in CapabilityRequestFilter received in UECapabilityEnquiry message.

In an embodiment, the first USIM (which has applied temporary capability change) informs its network (i.e., first network entity), while resuming RRC connection if the RRC connection is not setup for performing a new registration or attach. In an embodiment, the first USIM informs the first network entity (210) about temporary capability change while resuming RRC connection only if it has resulted in reduction of capabilities and skips informing the first network entity (210), if the capabilities have increased.

In an embodiment, the first USIM informs the network of temporary capability change, during RRC Resume procedure. In an embodiment, this may be informed in RRCResumeRequest or RRCResumeRequest1 message through a flag/enumerated. In an embodiment, this may be informed in RRCResumeRequest or RRCResumeRequest1 message through a ResumeCause. In an embodiment, the first network entity (e.g., gNB to which the first USIM is connected) (which has been informed by the first USIM about the temporary capability restriction through a flag or enumerated in RRCResumeRequest or RRCResumeRequest1) does not include the RRC IEs re-storeMCG-SCells-r16 and restoreSCG-r16 in the response message such as RRCResume message. In an embodiment, the first network entity (210) which has been informed by the first USIM about the temporary capability restriction through a flag or enumerated in RRCResumeRequest or RRCResumeRequest1 excludes including the RRC IE measConfig in the RRCResume message.

In an embodiment, if the first USIM receives a configuration (some IEs) in the RRC messages such as RRCReconfiguration or RRCResume which is not supported by the changed temporary capability (though it is supported in the permanent UE capability reported to the first network entity (210)), the first UE fails the procedure. In an embodiment, if the first USIM receives RRCResume message including measurement configuration which is not supported according to the temporary capabilities, the first USIM accepts the RRCResume message and sends RRCResumeComplete. In an embodiment, the first USIM informs the changed temporary capabilities in RRCResumeComplete. Alternatively, the changed temporary capabilities may be informed in another RRC message such as UEAssistanceInformation message. In an embodiment, the first USIM accepts the RRC message in above cases only if it is configured for reporting temporary capability changes by the first network entity (210) and fails the procedure otherwise. The configuration may be received in broadcast signaling such as NR SIB1. In an embodiment, first USIM fails the procedure when it is RRCReconfiguration procedure and succeeds the procedure when it is RRCResume procedure.

In an embodiment, the first USIM accepts the RRC message in above embodiments only if the RRC message includes a configuration for reporting temporary capability changes such as OtherConfig IE in NR RRC for reporting temporary capability changes and fails the procedure otherwise.

In an embodiment, if the first USIM receives a configuration (some IEs) in the RRC messages such as RRCReconfiguration or RRCResume which is not supported by the changed temporary capability (though it is supported in the permanent UE capability from the first network entity (210)), the first USIM does not fail the procedure, but completes the procedure successfully and sends the corresponding complete message (RRCReconfigurationComplete or RRCResumeComplete respectively). In an embodiment, the first USIM informs the first network entity (210) that the received configuration is not supported in the (current) temporary capability and may also include the temporary capability in the corresponding Complete message. In an embodiment, the configuration in the above embodiments is MIMO configuration. In an embodiment, the configuration in the above embodiments is band or band combination related information. In an embodiment, the configuration in the above embodiments is Carrier Aggregation related configuration. In an embodiment, the configuration in the above embodiments is dual connectivity related configuration. In an embodiment, the first USIM accepts the RRC message in above cases only if it is configured for reporting temporary capability changes by the first network entity (210) and fails the procedure otherwise.

In an embodiment, the first USIM accepts the RRC message in above embodiments only if the RRC message includes a configuration for reporting temporary capability changes such as OtherConfig IE in NR RRC for reporting temporary capability changes and fails the procedure otherwise.

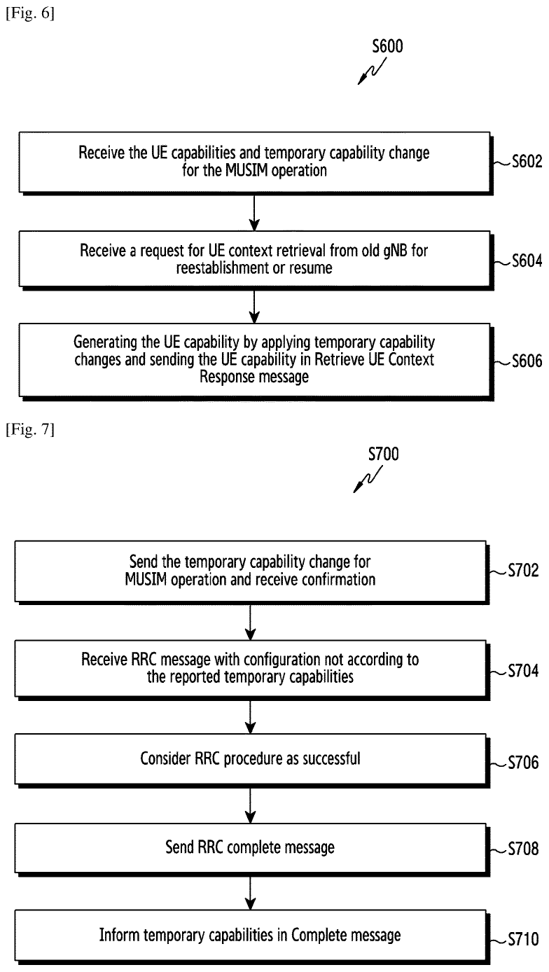

UE context retrieval during RRC Reestablishment and RRC Resume: In an embodiment, the old gNB in the first network entity (210) is informed whether the new gNB supports the handling of temporary UE capability or temporary UE capability changes during RRC Reestablishment and RRC Resume. In an embodiment, this would be done through Xn messages such as Xn setup message or Xn message of configuration update or Retrieve UE Context Request. In an embodiment, the OAM informs old gNB whether new gNB supports the handling of temporary UE capability or temporary UE capability changes. In an embodiment, the old gNB may be configured whether new gNB supports the handling of temporary UE capability or temporary UE capability changes. FIG. 6 depicts the process of UE capability handling during RRC Re-establishment and RRC Resume. FIG. 7 depicts the process of RRC Configuration handling with temporary capabilities.

In an embodiment, during the UE Context Retrieval procedure for RRC Reestablishment or RRC Resume, the old gNB of the first network entity (210) sends the latest UE capability (permanent UE capability) and the request for temporary UE capability changes received from the first USIM to new gNB. Request for temporary UE capability changes may be received by the old gNB in multiple messages (such as RRC messages like UAI or other messages) or through MAC CE. In an embodiment old gNB includes the request for temporary UE capability changes received from the first USIM (for e.g. the UAI for requesting temporary UE capability changes) to new gNB only if the temporary UE capability changes are accepted by the old gNB. In an embodiment, during the UE Context Retrieval procedure for RRC Reestablishment or RRC Resume towards a new gNB which does not support temporary UE capability changes, the old gNB generates a UE capability by applying the temporary UE capability changes on the permanent UE capability and informs new gNB as the UE capability to be used.

FIG. 2 illustrates various hardware components of the Multi-SIM device (100), according to the embodiments as disclosed herein. In an embodiment, the Multi-SIM device (100) includes the plurality of UEs (110-130), a processor (140), a communicator (150), a memory (160) and a temporary UE capability handling controller (170). The processor (140) is coupled with the communicator (150), the memory (160) and the temporary UE capability handling controller (170).

The temporary UE capability handling controller (170) completes the RRC procedure successfully upon receiving the configuration in the RRC message from the network entity, where the configuration is not supported by the restricted temporary capability. For example, the RRC message can be the RRCResume message. Further, the temporary UE capability handling controller (170) sends the complete message corresponding to the RRC procedure. For example, the complete message can be the RRCResumeComplete,

In an embodiment, the temporary UE capability handling controller (170) accepts the RRC message when the first UE (110) is configured for reporting the restricted temporary capability changes by the network entity. In an embodiment, the temporary UE capability handling controller (170) fails the RRCResume procedure when the first UE (110) is not configured for reporting the restricted temporary capability changes by the network entity. In an embodiment, the temporary UE capability handling controller (170) fails the RRCReconfguration procedure and avoids to send RRCReconfigurationComplete when the first UE (110) receives capabilities not supported by the temporary capabilities.

The temporary UE capability handling controller (170) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (140) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (140) may include multiple cores and is configured to execute the instructions stored in the memory (160).

Further, the processor (140) is configured to execute instructions stored in the memory (160) and to perform various processes. The communicator (150) is configured for communicating internally between internal hardware components and with external devices via one or more networks. The memory (160) also stores instructions to be executed by the processor (140). The memory (160) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (160) may, in some examples, be considered a non-transitory storage medium. The term “non-transitory” may indicate that the storage medium is not embodied in a carrier wave or a propagated signal. However, the term “non-transitory” should not be interpreted that the memory (160) is non-movable. In certain examples, a non-transitory storage medium may store data that can, over time, change (e.g., in Random Access Memory (RAM) or cache).

Although FIG. 2 shows various hardware components of the Multi-SIM device (100) but it is to be understood that other embodiments are not limited thereon. In other embodiments, the Multi-SIM device (100) may include less or more number of components. Further, the labels or names of the components are used only for illustrative purposes and does not limit the scope of the invention. One or more components can be combined together to perform the same or substantially similar function in the Multi-SIM device (100).

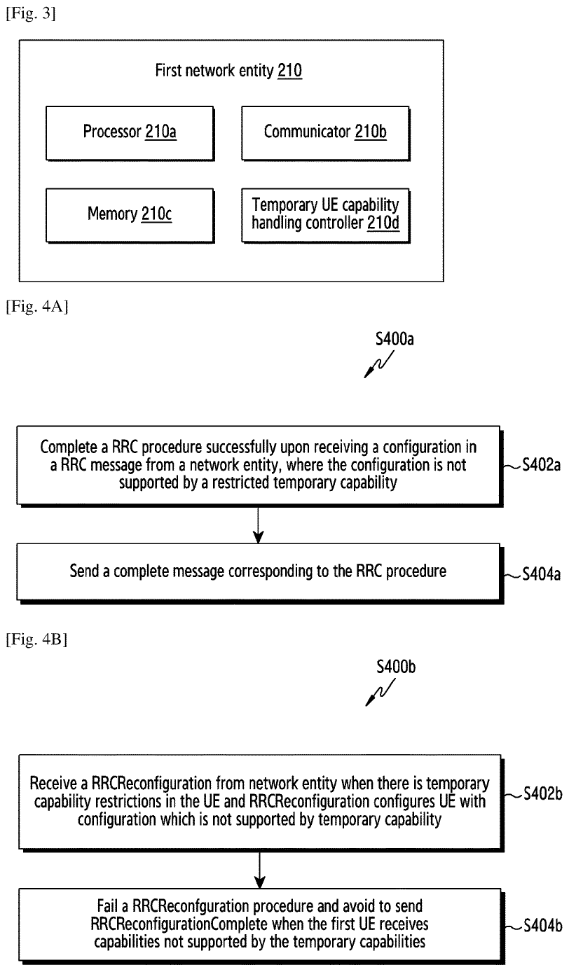

FIG. 3 illustrates various hardware components of the first network entity (210), according to the embodiments as disclosed herein. In an embodiment, the first network entity (210) includes a processor (210a), a communicator (210b), a memory (210c) and a temporary UE capability handling controller (210d). The processor (210a) is coupled with the communicator (210b), the memory (210c) and the temporary UE capability handling controller (210d).

The temporary UE capability handling controller (210d) receives the message for temporary capability change from the first UE (110) of the multi-SIM device (100). In an embodiment, the temporary UE capability handling controller (210d) accepts all the temporary capability changes requested by the first UE (110) and sends the RRC Reconfiguration message to inform acceptance all the temporary capability changes requested by the first UE (110) to the multi-sim device (100). In another embodiment, the temporary UE capability handling controller (210d) rejects all the temporary capability changes requested by the first UE (110) and sending the RRC Reconfiguration message to inform rejection all the temporary capability changes requested by the first UE (110) to the multi-sim device (210d).

The temporary UE capability handling controller (210d) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210a) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210a) may include multiple cores and is configured to execute the instructions stored in the memory (210c).

Further, the processor (210a) is configured to execute instructions stored in the memory (210c) and to perform various processes. The communicator (210b) is configured for communicating internally between internal hardware components and with external devices via one or more networks. The memory (210c) also stores instructions to be executed by the processor (210a). The memory (210c) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (210c) may, in some examples, be considered a non-transitory storage medium. The term “non-transitory” may indicate that the storage medium is not embodied in a carrier wave or a propagated signal. However, the term “non-transitory” should not be interpreted that the memory (210c) is non-movable. In certain examples, a non-transitory storage medium may store data that can, over time, change (e.g., in Random Access Memory (RAM) or cache).

Although FIG. 3 shows various hardware components of the first network entity (210) but it is to be understood that other embodiments are not limited thereon. In other embodiments, the first network entity (210) may include less or more number of components. Further, the labels or names of the components are used only for illustrative purposes and does not limit the scope of the invention. One or more components can be combined together to perform the same or substantially similar function in the first network entity (210).

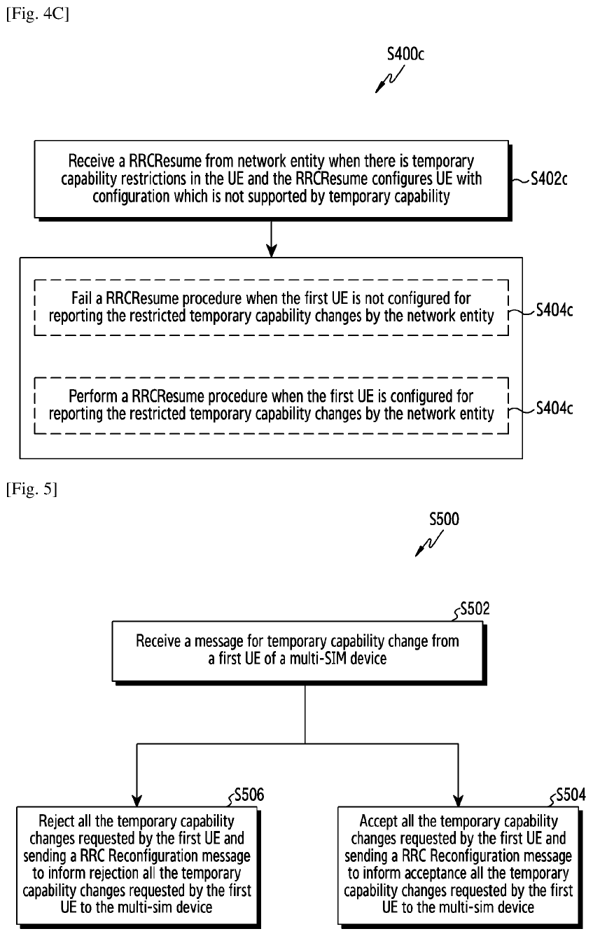

FIG. 4A illustrates a flow chart (S400a) illustrating a method, implemented by the Multi SIM device (100), for handling the temporary UE capability change for the Multi-SIM device (110), according to the embodiments as disclosed herein. The operations (S402a-S404a) are handled by the temporary UE capability handling controller (170).

At S402a, the method includes completing the RRC procedure successfully upon receiving the configuration in the RRC message from the network entity (210 or 220). The configuration is not supported by the restricted temporary capability. At S404a, the method includes sending the complete message corresponding to the RRC procedure.

FIG. 4B is a flow chart (400b) illustrating a method, implemented by the Multi-SIM device (100), for handling the temporary UE capability change for the Multi-SIM device (100) based on the RRCReconfiguration, according to the embodiments as disclosed herein. The operations (S402b-S404b) are handled by the temporary UE capability handling controller (170).

At S402b, the method includes receiving the RRCReconfiguration from the network entity when there is temporary capability restrictions in the UE and the RRCReconfiguration configures the UE (110) with configuration which is not supported by temporary capability. At step S404b, the method includes failing the RRCReconfguration procedure and avoiding to send the RRCReconfigurationComplete when the first UE (110) receives capabilities not supported by the temporary capabilities.

FIG. 4C is a flow chart (400c) illustrating a method, implemented by the Multi-SIM device (100), for handling the temporary UE capability change for the Multi-SIM device (100) based on the RRCResume, according to the embodiments as disclosed herein. The operations (S402c-S406c) are handled by the temporary UE capability handling controller (170).

At S402c, the method includes receiving the RRCResume from the network entity when there is temporary capability restrictions in the UE (110) and the RRCResume configures the UE (110) with configuration which is not supported by the temporary capability. At step S404c, the method includes failing the RRCResume procedure when the first UE (110) is not configured for reporting the restricted temporary capability changes by the network entity. Alternatively, at step S406c, the method includes performing the RRCResume procedure when the first UE (110) is configured for reporting the restricted temporary capability changes by the network entity.

FIG. 5 illustrates a flow chart (S500) illustrating a method, implemented by the first network entity (210), for handling the temporary UE capability change for the Multi-SIM device (100), according to the embodiments as disclosed herein. The operations (S502-S506) are handled by the temporary UE capability handling controller (210d).

At S502, the method includes receiving the message for temporary capability change from the first UE (110) of the multi-sim device (100). In an embodiment, at S504, the method includes accepting all the temporary capability changes requested by the first UE (110) and sending the RRC Reconfiguration message to inform acceptance all the temporary capability changes requested by the first UE (110) to the multi-sim device (100). In another embodiment, at S506, the method includes rejecting all the temporary capability changes requested by the first UE (110) and sending the RRC Reconfiguration message to inform rejection all the temporary capability changes requested by the first UE (110) to the multi-sim device (100).

FIG. 6 illustrates a flow chart (S600) illustrating a process of UE capability handling during RRC Re-establishment and RRC Resume, according to embodiments as disclosed herein. The operations (S602-S606) are handled by the temporary UE capability handling controller (170).

At S602, the method includes receiving the UE capabilities and temporary capability change for the MUSIM operation. At S604, the method includes receiving the request for UE context retrieval from old Gnb for reestablishment or resume. At S606, the method includes generating the UE capability by applying temporary capability changes and sending the UE capability in Retrieve UE Context Response message.

FIG. 7 illustrates a flow chart (S600) illustrating a process of RRC Configuration handling with temporary capabilities, according to embodiments as disclosed herein. The operations (S702-S708) are handled by the temporary UE capability handling controller (170).

At S702, the method includes sending the temporary capability change for the MUSIM operation and receiving the confirmation. At S704, the method includes receiving the RRC message with the configuration not according to the reported temporary capabilities. At S706, the method includes considering the RRC procedure as successful. At S708, the method includes sending the RRC complete message. At S710, the method includes informing the temporary capabilities in the complete message. Alternatively, the temporary capabilities may be informed in other RRC messages following the complete message, such as UE Assistance Information message.

The various actions, acts, blocks, steps, or the like in the flow charts (S400-S700) may be performed in the order presented, in a different order or simultaneously. Further, in some embodiments, some of the actions, acts, blocks, steps, or the like may be omitted, added, modified, skipped, or the like without departing from the scope of the invention.

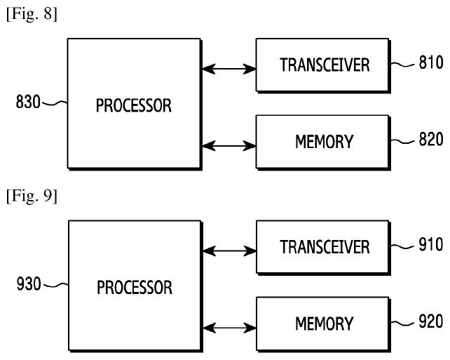

FIG. 8 illustrates a block diagram illustrating a structure of a UE according to embodiment of the disclosure. FIG. 8 corresponds to the example of the Multi-SIM device of FIG. 2.

As shown in FIG. 8, the UE according to an embodiment may include a transceiver 810, a memory 820, and a processor (or a controller) 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor or at least one controller.

The transceiver 810 collectively refers to a UE receiver and a UE transmitter, and may transmit/receive a signal to/from a base station or a network entity. The signal transmitted or received to or from the base station or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may control a series of processes such that the UE operates as described above. For example, the transceiver 810 may receive a data signal including a control signal transmitted by the base station or the network entity, and the processor 830 may determine a result of receiving the control signal and the data signal transmitted by the base station or the network entity.

FIG. 9 illustrates a block diagram illustrating a structure of a base station according to embodiment of the disclosure. FIG. 9 corresponds to the example of the network entity of FIG. 3.

As shown in FIG. 9, the base station according to an embodiment may include a transceiver 910, a memory 920, and a processor (or a controller) 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip. Also, the processor 930 may include at least one processor at least one controller.

The transceiver 910 collectively refers to a base station receiver and a base station transmitter, and may transmit/receive a signal to/from a terminal or a network entity. The signal transmitted or received to or from the terminal or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CD-ROM, and a DVD, or a combination of storage media.

The processor 930 may control a series of processes such that the base station operates as described above. For example, the transceiver 910 may receive a data signal including a control signal transmitted by the terminal, and the processor 930 may determine a result of receiving the control signal and the data signal transmitted by the terminal.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the scope of the embodiments as described herein.

1. A user equipment (UE) in a wireless communication system, the UE comprising:
a transceiver; and
a controller coupled with the transceiver, and configured to:
receive, from a base station, a radio resource control (RRC) message including at least one information,
identify that the UE is unable to comply with the at least one information included in the RRC message, and
in case that the UE is configured to report a temporary capability changing for a multi-universal subscriber identity module (MUSIM) operation, transmit, to the base station, a RRC complete message including information associated with the UE temporary capability changing.

2. The UE of claim 1, wherein the UE supports the UE temporary capability changing for the MUSIM operation.

3. The UE of claim 1, wherein, in case that the UE is not configured to report the temporary capability changing for the MUSIM operation, a procedure of failure handling for the RRC message is performed.

4. The UE of claim 1,
wherein the RRC message is one of an RRC resume message or an RRC reconfiguration message, and
wherein the RRC complete message is one of an RRC resume complete message or an RRC reconfiguration message.

5. A base station in a wireless communication system, the base station comprising:
a transceiver; and
a controller coupled with the transceiver, and configured to:
transmit, to a user equipment (UE), a radio resource control (RRC) message including at least one information, and
in case that the UE is unable to comply with the at least one information included in the RRC message and the UE is configured to report a temporary capability changing for a multi-universal subscriber identity module (MUSIM) operation, receive, from the UE, a RRC complete message including information associated with the UE temporary capability changing.

6. The base station of claim 5, wherein the UE supports the UE temporary capability changing for the MUSIM operation.

7. The base station of claim 5, wherein, in case that the UE is not configured to report the temporary capability changing for the MUSIM operation, a procedure of failure handling for the RRC message is performed.

8. The base station of claim 5,
wherein the RRC message is one of an RRC resume message or an RRC reconfiguration message, and
wherein the RRC complete message is one of an RRC resume complete message or an RRC reconfiguration message.

9. A method performed by a user equipment (UE) in a wireless communication system, the method comprising:
receiving, from a base station, a radio resource control (RRC) message including at least one information;
identifying that the UE is unable to comply with the at least one information included in the RRC message; and
in case that the UE is configured to report a temporary capability changing for a multi-universal subscriber identity module (MUSIM) operation, transmitting, to the base station, a RRC complete message including information associated with the UE temporary capability changing.

10. The method of claim 9, wherein the UE supports the UE temporary capability changing for the MUSIM operation.

11. The method of claim 9, wherein, in case that the UE is not configured to report the temporary capability changing for the MUSIM operation, a procedure of failure handling for the RRC message is performed.

12. The method of claim 9,
wherein the RRC message is one of an RRC resume message or an RRC reconfiguration message, and
wherein the RRC complete message is one of an RRC resume complete message or an RRC reconfiguration message.

13. A method performed by a base station in a wireless communication system, the method comprising:
transmitting, to a user equipment (UE), a radio resource control (RRC) message including at least one information; and
in case that the UE is unable to comply with the at least one information included in the RRC message and the UE is configured to report a temporary capability changing for a multi-universal subscriber identity module (MUSIM) operation, receiving, from the UE, a RRC complete message including information associated with the UE temporary capability changing.

14. The method of claim 13, wherein the UE supports the UE temporary capability changing for the MUSIM operation.

15. The method of claim 13,
wherein, in case that the UE is not configured to report the temporary capability changing for the MUSIM operation, a procedure of failure handling for the RRC message is performed,
wherein the RRC message is one of an RRC resume message or an RRC reconfiguration message, and
wherein the RRC complete message is one of an RRC resume complete message or an RRC reconfiguration message.
